(19) United States
(12) Patent Application Publication
(10) Pub. No.: US 2010/0000416 A1
(43) Pub. Date: Jan. 7, 2010

(54) PERCOLATOR DEVICE

(76) Inventor: Paul Mulhauser, New York, NY (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/498,029

(22) Filed: Jul. 6, 2009

Related U.S. Application Data
(60) Provisional application No. 61/078,628, filed on Jul. 7, 2008.

(51) Int. Cl. A47J 31/10

(52) U.S. Cl. 99/306; 99/300; 99/307; 99/316; 99/317

(57) ABSTRACT

A percolating device includes a tank operable to hold liquid and having a top portion, a side wall, and a bottom portion. A strainer basket is positioned near the top portion of the tank and is operable to contain coffee grounds. A heating element is operable to heat a liquid contained in the tank and a tube directs heated liquid from the heating element to the strainer basket such that the heated liquid enters the strainer basket. A partition sealably engages the side wall of the tank and is operable to substantially separate liquid that has entered and fallen through the strainer basket from liquid that has not entered and fallen through the strainer basket.

### RELATED APPLICATIONS

This application claims priority to U.S. Provisional Patent Application Ser. No. 61/078,628 filed Jul. 7, 2008. The entire content of that application is incorporated by reference herein.

### BACKGROUND

The present invention relates to coffee brewing devices, and more specifically to coffee percolator devices.

Coffee percolators were developed in the 1800's as a means to extract coffee from ground coffee beans. Practically speaking, the coffee percolator is a pot in which boiling water is forced repeatedly up through a central tube to filter back down through a basket of ground coffee beans. However, the coffee percolator has fallen out of favor with the advent of drip coffee makers and other various manners of coffee makers because the percolator manner of brewing coffee violates basic good practices for brewing coffee. Once coffee is extracted from the beans, it generally should not be reheated or boiled, as the coffee can then become scorched and/or bitter. However, percolators work by re-boiling the already brewed coffee and then repeatedly re-dispersing it back through the grounds over and over again—a process that removes coffee's aromatic oils and destroys the flavor.

### SUMMARY

The invention provides an improved coffee or beverage percolator that does not re-apply brewed coffee through the grounds in a repeated manner. Instead of continually boiling and re-applying the brewed coffee through the basket containing the grounds, the percolator of the present invention disperses the heated water over and through the grounds once, and then substantially separates the brewed coffee from the water while maintaining the coffee's heat without overheating, so that the taste of the coffee is not altered or degraded.

In one embodiment, the invention provides a percolating device including a tank operable to hold liquid and having a top portion, a side wall, and a bottom portion. A strainer basket is positioned near the top portion of the tank and is operable to contain coffee grounds. A heating element is operable to heat a liquid contained in the tank and a tube directs heated liquid from the heating element to the strainer basket such that the heated liquid enters the strainer basket. A partition sealably engages the side wall of the tank and is operable to substantially separate liquid that has entered and fallen through the strainer basket from liquid that has not entered and fallen through the strainer basket.

In another embodiment the invention provides a method of brewing coffee using a percolating device having a tank with a top portion, a side wall, and a bottom portion. The method includes providing heated water from the bottom portion of the tank through a tube to a strainer basket containing coffee grounds and that is positioned adjacent the top portion of the tank. Next, the heated water is passed through the strainer basket such that the heated water exits from the strainer basket as coffee and remains in the tank. The coffee is kept substantially separated from the remainder of the water in the tank that has not been provided to and passed through the strainer basket.

In yet another embodiment, the invention provides a partition for use in a percolator device. The partition includes a disk having an outer periphery and a central aperture. A seal is coupled to the outer periphery and configured to sealably engage a side wall of a tank of the percolator device.

Other aspects of the invention will become apparent by consideration of the detailed description and accompanying drawings.

### BRIEF DESCRIPTION OF THE DRAWINGS

FIG. 1 is a side cross-section view of a coffee percolator and dispenser according to one embodiment of the invention.

FIG. 1b is an enlarged partial cross-section view of FIG. 1.

FIG. 2 is a partial exploded view of the coffee percolator and dispenser of FIG. 1, shown with a partition and strainer basket removed from the tank.

FIG. 3 is a partial top perspective view of the coffee percolator and dispenser of FIG. 1, shown with the partition positioned in the tank.

FIG. 4 is a front view of the coffee percolator and dispenser of FIG. 1.

FIG. 5 is a partial top perspective view illustrating the cover of the percolator and dispenser.

FIG. 6 is a partial, side cross-section view illustrating an alternate partition configuration.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

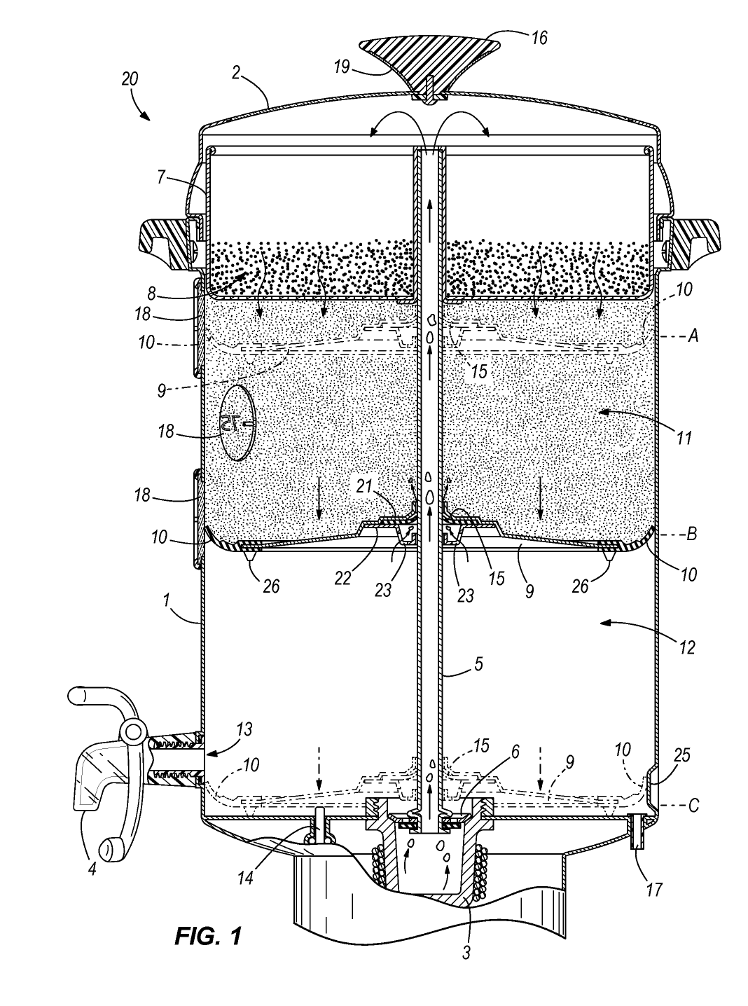

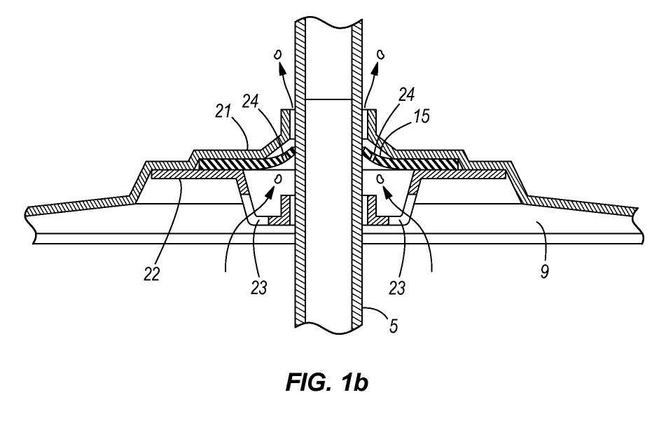

Turning to FIG. 1, according to one embodiment, a coffee percolator 20 is comprised of a tank 1 that is operable to hold liquid (e.g., water). The tank 1 may be cylindrical and vertically oriented as shown in FIG. 1, with an opening at its top or upper portion and a closure on the bottom such that the tank may be filled with water. However, tank 1 may also have other cross-sectional configurations such as ovaloid, obround, or rectangular, or other shapes operable to contain water. Further, tank 1 has historically been comprised of a metal such as aluminum or stainless steel, which may be single or double wall for insulation, but it will be appreciated that tank 1 may instead comprise other materials such as glass, plastics, ceramics, or other materials operable to hold water at a range from about 34° F. to at or near water's boiling temperature. Coffee percolator 20 further comprises a removable cover 2 operable to be placed on tank 1 to constrain fluids and retain heat. Further, coffee percolator 20 comprises a heating element 3 generally at or near the bottom portion of tank 1 to heat fluids contained within tank 1. It will be appreciated that heating element 3 may be associated with thermal controls to adjust its heat output.

Coffee percolator 20 further comprises a tube 5 traveling from the bottom of tank 1 to a position near the top of tank 1 such that water heated by heating element 3 is pushed up through tube 5 and into a filter or strainer basket 7, causing hot fluid to trickle through ground coffee or other material, through a sieve-like base of strainer basket 7 such that the ground material is maintained within strainer basket 7 while the extracted coffee or other fluid falls back down into tank 1. Historically, tube 5 has been centrally located within the center of a cylindrical tank 1, although tube 5 may be placed in other locations, provided that it allows water heated by heating element 3 to be pushed up tube 5 and into strainer basket 7. Alternatively, the tube 5 need not be centrally located within the tank 1, or need not be within the tank 1 at all. Optionally, tube 5 may include a tube base 6, which may be an enlarged end to fit over heating element 3 such that water boiled locally by heating element 3 is constrained and directed to flow up through tube 5. The tube 5 can be constrained downwardly by the weight of the basket 7, the weight of the grounds 8 in the basket 7, and/or the cover 2 to prevent the tube 5 from rising with air bubbles (and pressure) from the heating element 3 during brewing.

Coffee percolator 20 further comprises strainer basket 7 that is concentrically engaged onto the upper portion of tube 5 as shown in FIG. 1, and is constrained in or above the upper portion of tank 1. In alternative embodiments, the strainer basket 7 need not be concentrically engaged onto the upper portion of the tube 5. Strainer basket 7 may be held in position vertically by stepped features on the inner walls of tank 1 (not shown), on the outside of tube 5 (not shown), or by resting on the top of the tube 5 as shown in FIGS. 1-3. Measured portions of coffee grounds 8 and/or other materials may be placed into strainer basket 7 for brewing. As discussed above, the bottom surface of strainer basket 7 is optionally finely perforated to prevent passage of the contained coffee grounds 8 while enabling brewed coffee to pass through the perforations. The basket may also receive a filter material, such as paper or mesh, to filter coffee grounds 8.

In previous percolators, the brewed coffee drips through strainer basket perforations and then falls into the heated volume of water within the tank. The mix of water and brew were then continually and repeatedly re-boiled and re-circulated though the same grounds. However, re-boiling coffee is known to remove oils and destroys the flavor of coffee.

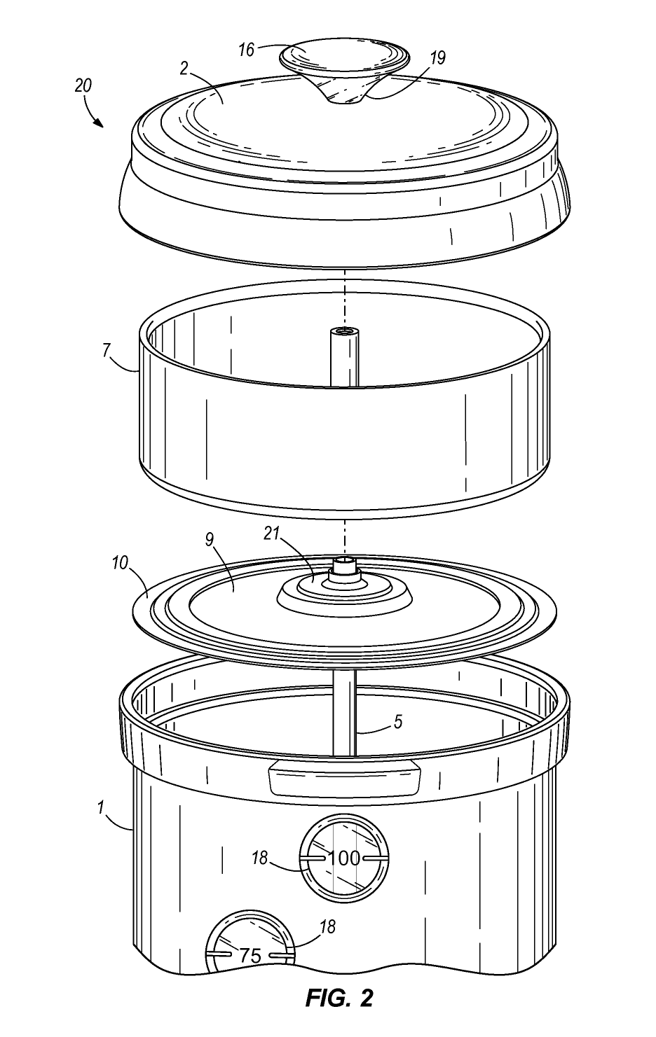

Conversely, as shown in FIG. 1, coffee percolator 20 substantially prevents brewed coffee from commingling with the water that has not been passed through strainer basket 7. This is accomplished through the use of a baffle or partition 9 containing an annular seal 10 in contact with the side wall(s) of tank 1. In one embodiment best shown in FIGS. 1 and 2, partition 9 is a generally horizontally-extending member and can take the form of a disk with an opening in the form of a central aperture having an integral or separate seal 15 that sealably engages around tube 5. The seal 15 geometry may be a simple wiper blade, a concave bowl shape, an O-ring, or other form. Seal 15 may be joined to partition 9 by capturing an edge, by crimping the seal 15 between surfaces, by forming the seal 15 integral to the partition 9 itself, or by other methods.

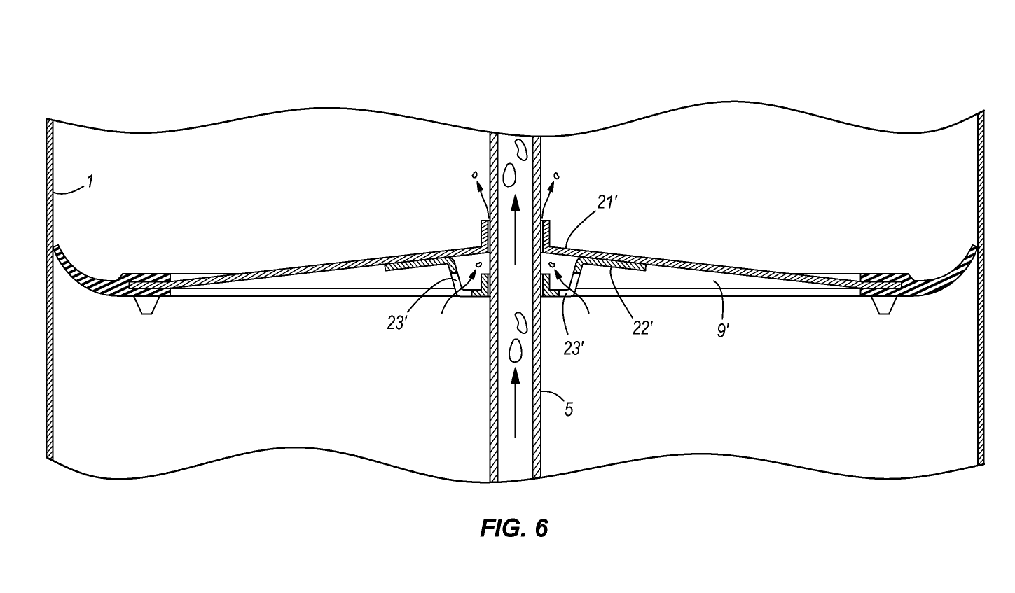

According to one embodiment, fluid flow past the outer edges of the partition 9 is restricted or minimized by means of annular seal 10 affixed around the outer periphery (e.g., circumference) of partition 9, which loosely wipes upon the inner walls of the tank 1. Annular seal 10 and seal 15 are optionally comprised of a thin, low durometer, high temperature resistant elastomer such as silicone. Annular seal 10 is optionally die-stamped as one or more flat rings or molded or overmolded to form. The annular seal 10 geometry may be a simple wiper blade, a concave bowl shape, an O-ring, or other form. As illustrated in FIG. 1, the annular seal 10 includes a stepped, feathered edge that decreases in thickness as it extends radially outward. The thinnest, outer diameter of the annular seal 10 reduces the sliding friction with the tank 1, while the thicker portion of the annular seal closer to the center of the partition 9 provides more structural support to help center the partition 9 within the tank 1. While the stepped surface is shown as the upper surface in FIGS. 1-3, other embodiments may have the lower surface of the annular seal 10 be stepped. In yet other embodiments (see FIG. 6), the annular seal 10 could more smoothly taper from thicker to thinner, without utilizing a stepped surface. The construction method of the annular seal 10 may dictate the geometry, as the stepped surface could be a result of stacking multiple die-stamped sheets on top of one another, while a more smoothly tapered seal could result from a molding process. Annular seal 10 may be joined to partition 9 by capturing an edge of the partition 9 (as shown in FIG. 1), by crimping the seal 10 between surfaces, by forming the seal integral to the partition itself, or by other methods.

Partition 9 may be flat or structurally formed, and may be made at least in part of thermally conductive material such as aluminum or stainless steel to allow the heating element 3 to continue to heat brewed coffee through the partition once brewing is complete and the partition reaches position C, as discussed further below. The partition 9 can also be formed with means for releasing any air that may be trapped underneath the partition 9. Trapped, and perhaps pressurized air, can act as an insulation barrier that detracts from heat transfer through the partition 9 to the brewed coffee 11 above the partition 9. It can also impact the ability of the partition 9 to move downwardly in the tank 1 (due to added buoyancy created by the trapped air). The air may be trapped upon initial insertion of the partition 9 into the tank and/or during the heating and percolating process, in which air is introduced into the tank 1. The partition 9 can employ different means to help with the release of trapped air, and is constructed to include a high point or highest point, where the air release feature or means is preferably located.

As shown in FIGS. 1 and 1b the partition 9 is structurally formed from a primary member 21 (e.g., a metal stamping) that is formed to have a high point at the opening adjacent the tube 5. The high center and convex form of the primary member 21 directs rising air bubbles to the center of the partition 9. A secondary member 22 (e.g., a metal stamping) is centrally-located beneath (or alternatively above) the primary member 21. As illustrated, the secondary member 22 has a self-centering fit with the primary member 21 for easy assembly, and can be spot-welded or otherwise secured to the primary member 21. The seal 15 is constrained between the members 21 and 22. This construction provides two spaced-apart, tube-receiving portions (i.e., the members 21 and 22) to help prevent tipping of the partition 9 within the tank 1 that could lead to flow around the partition 9 and loss of fluid separation in the tank 1. In other words, the construction helps to keep the partition 9 oriented substantially perpendicular to the tube 5.

Air trapped beneath the partition 9 can pass through openings 23 in the secondary member 22 and into the area between the secondary member 22 and the seal 15. The air can escape past the seal 15 where it engages the tube 5 (such that the seal 15 is resilient enough to act like a one-way valve), or the seal 15 can include one or more apertures 24 that provide air passages to allow the trapped air to escape upwardly. The air then passes between the primary member 21 and the tube 5 and upward to the top of the tank 1.

In other embodiments, the high point of the partition 9 could be at the radially-outer diameter where the annular seal 10 engages the tank walls. In this case, annular seal 10 can be sufficiently resilient to facilitate the release of any trapped air from below partition 9 (such that the seal 10 acts like a one-way valve), allowing any trapped and/or heated air to escape upwardly past partition 9 to the top of tank 1. Alternatively, one or more apertures (similar to apertures 24) could be formed in the annular seal 10 to provide air passages. Further alternatively, separate air release ports (not shown) may be included through other parts of the partition 9, for example in the primary member 21, to allow the passage of air from beneath the partition 9. The means for releasing trapped air may result in a slight or insignificant amount of the brewed coffee 11 passing beneath the partition 9 (e.g., though the apertures 24 or past the seals 10, 15), however, this insubstantial amount does not negatively impact the quality of the brewed coffee 11 and is still considered as resulting in the substantial separation of water 12 and coffee 11 intended with the present invention.

FIG. 6 illustrates an alternate embodiment of the partition 9′ in which there is no central seal 15 in the central aperture for sealably engaging the tube 5. The primary member 21′ is still formed with a high point adjacent the tube 5, but does not include the same stepped geometry as the member 21. The secondary member 22′ is similar to the member 22 and allows trapped air to pass through apertures 23′ and into the area between the members 21′ and 22′. The air can escape past the partition 9′ between the first member 21′ and the tube 5 as there is a close slide fit engagement therebetween, but not a complete seal. In the illustrated embodiment, the clearance between the first member 21′ and the tube 5 is about the same in area as the area of the apertures 24 discussed above.

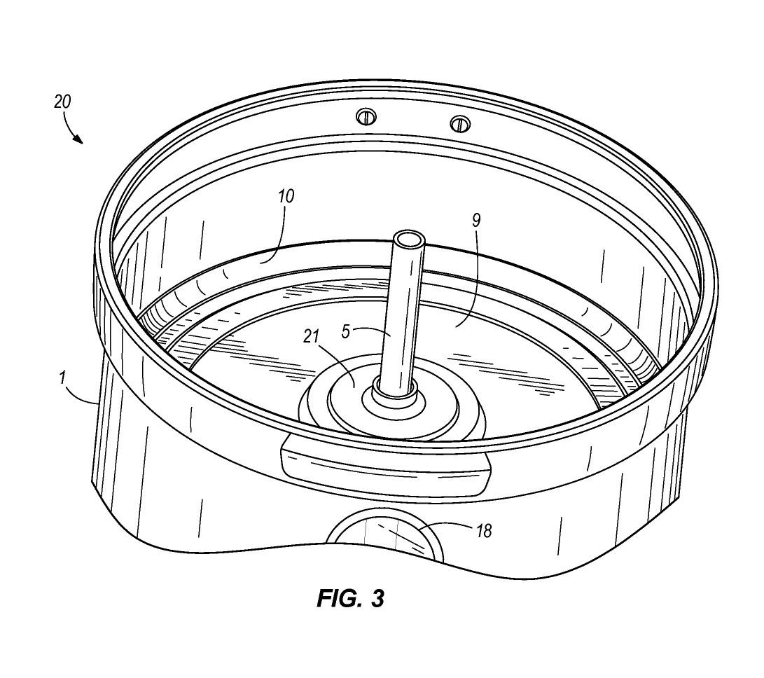

In practice, partition 9 is allowed to freely move vertically within tank 1 and the vertical position of partition 9 is maintained based upon the volume of coffee generated at any given time as compared to the volume of water remaining in the tank below partition 9. As shown in FIGS. 1 and 3, tank 1 is first filled with water 12 to a point just below point A, and partition 9 is then placed over the tube 5 and lowered into tank 1 such that partition 9 sits on top of the water level at point A. According to one embodiment, partition 9 is sufficiently light and the wiping resistance of annular seal 10 enables the partition 9 to stay in position under its own weight. The partition 9 can be manually pushed downward to help release any initially trapped air.

As heating element 3 heats water 12 under partition 9 and pushes hot water through tube 5 and over coffee grounds 8 and through strainer basket 7, brewed coffee begins to accumulate on top of partition 9 and water is removed from below partition 9, causing it to be moved downwardly such that brewed coffee 11 sits above partition 9 while unbrewed water 12 remains below partition 9. As shown at position B in FIG. 1, when approximately half of the water has been boiled and pushed up tube 5 and through coffee grounds 8, brewed coffee 11 will comprise about half the volume of the liquid in percolator 20—the half above the partition—and the heated water 12 will comprise about half the liquid in percolator 20. The cumulative added weight of the brewed coffee deposited upon partition 9 as well as the removal of water below partition 9 contributes to the partition's downward movement. As can be seen, partition 9 operates as a separator between water 12 and brewed coffee 11, substantially preventing brewed coffee from being re-boiled and re-percolated.

According to one embodiment, as the partition 9 nears the bottom of the tank 1 (position C), annular seal 10 passes by an exit orifice 13, which communicates with a spigot 4. Prior to the passing below exit orifice 13, only unbrewed water may be served from the spigot. Freshly brewed coffee 11 is available to be served from the spigot 4 once the partition 9 has passed below the exit orifice 13.

According to one embodiment, partition 9, after passing exit orifice 13, ultimately is positioned near or at the bottom of tank 1 when the last of the water 12 is boiled up the tube 5 from below partition 9 and with the weight of the entire fluid contents of the tank then upon partition 9. A trip switch, for example, a switch such as switch 14 may be located at or near the bottom of tank 1 to sense and/or be triggered by the presence of the partition 9, thereby triggering heating element 3 to change operation (e.g., to turn off or to switch to a lower temperature mode) for maintaining the brewed coffee 11 at a desired serving temperature without boiling. Any number of switch types may be used including sealed mechanical switches, proximity switches, or interfaces for remote switches.

The percolator device 20 includes features designed to help prevent formation of an air void beneath the partition 9 adjacent the heating element 3 when the partition is at position C at the bottom of the tank 1. Such an air void could provide an insulating barrier to continued warming of the brewed coffee 11. In extreme cases, an air void or the total absence of liquid around the heating element 3 could also damage the heating element 3 (e.g., burning out a switch). In addition to the air release features already discussed above, the wall of the tank 1 can include an inwardly extending projection or boss 25 that deflects the annular seal 10 in a manner to allow the passage of brewed coffee 11 around the seal 10 and underneath the partition 9. The brewed coffee 11 beneath the partition 9 ensures that there will be liquid in the area surrounding the heating element 3. The boss 25 is preferably positioned on the opposite portion of the tank 1 from the spigot 4.

The underside of the partition 9 can include projections 26 sized and configured to keep the partition 9 from bottoming-out on the tank bottom and blocking the flow of coffee 11 into the well adjacent the heating element 3. The projections 26 can be integrally formed on the underside of the annular seal 10, or can be separate features coupled with the seal 10 or the members 21 and 22 of the partition 9. In some embodiments, the projections 26 can be stiffening ribs or features formed on the underside of the partition 9.

Once coffee is brewed and dispensed, partition 9 can be easily retrieved by removal of the tube 5 as the flared bottom 6 of the tube will lift partition 9 as tube 5 is removed. Alternatively, a lifting member may be added to raise the partition 9, resetting it to its upper start position. Further optionally, a valve or port 17 (see FIG. 1) may be present near the bottom of tank 1 to refill tank 1 with water, thereby pushing partition 9 upwards.

The above description teaches the basic principles of the invention. Other functional features may be added or considered for further performance enhancements and user benefit. For example, a secondary heating element or elements may be included which are specifically intended to heat the bottom of tank 1.

The partition 9 material is optionally thermally conductive so as to help keep the freshly brewed coffee at a desired serving temperature by convection via the heated water or heating element 3 below the partition. The partition geometry may also be optionally configured with a flat bottom or a bottom which closely matches the tank bottom so as to most efficiently transmit heat from the bottom of the tank 1 to maintain the freshly brewed tank contents heated to desired serving temperature. The partition 9 can be included as part of a new percolator device, or can be purchased separately to be used in an existing percolator device. The partition 9 can be sized and configured to work with existing percolator devices.

Further optionally, a clear external tube or equivalent such means may be used to visualize total fluid volume within the tank. Position of the partition will have little or no effect on accuracy of such a display. However, if such typical volume display tube communicates with the tank only through the spigot or from the bottom of the tank and has an air vent at its upper extremity, then the water within the display tube will remain substantially clear until the partition passes below the exit orifice and should change to coffee color upon dispensing the first cup.

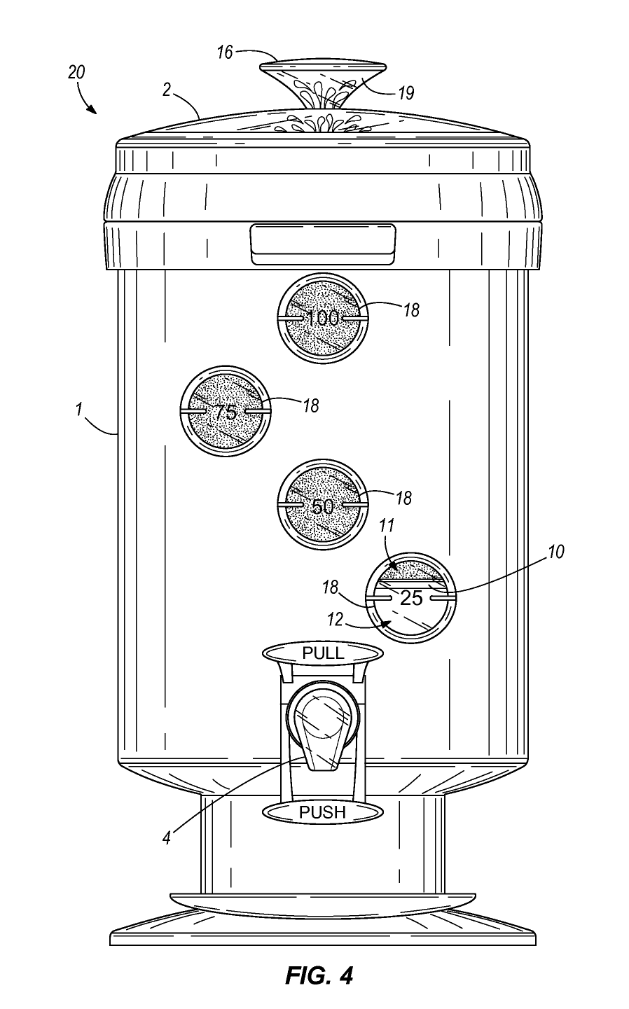

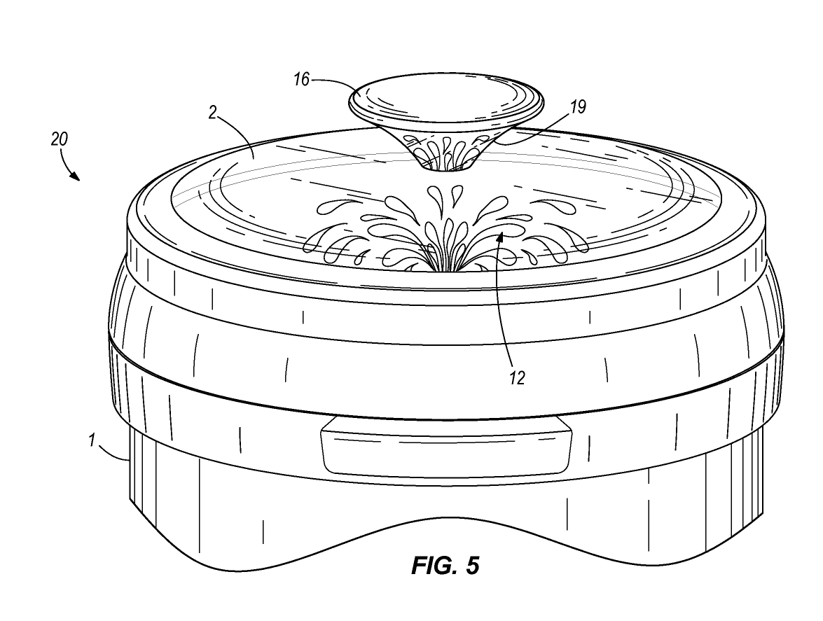

Optionally, as shown in FIGS. 1-4, a window aperture 18 or series of window apertures 18 may provide useful visual indication of the brewing progress as the partition 9 moves downward with coffee color above and substantially clear water (some light tinting may occur due to the air releasing features discussed above) below. Each of the partition 9 (or at least the annular seal 10), the coffee 11, and the water 12 can be seen through the window apertures 18 at different times or intervals during the brewing process. As yet another option, a clear spigot 4 may be utilized to show when coffee is available for dispensing, as the spigot 4 will show water at the spigot 4 until coffee is ready to be dispensed, and will show coffee when the partition 9 passes below the exit orifice 13. In yet another optional embodiment, as best shown in FIGS. 2, 4 and 5, cover 2 may optionally comprise a transparent or translucent material to allow a user to see the substantially clear water percolating up tube 5 and into strainer basket 7. A handle 16 coupled to the cover 2 can include a reflective underside (e.g., a polished chrome finish or insert 19) to further highlight and display the percolating water.

The tank 1 may be optionally plumbed to drain, rinse and refill the tank contents with a port 17 at the bottom portion of the tank 1. Introduction of the fresh water through the bottom of the tank 1 will enable the partition 9 to be raised from the bottom of the tank 1 back upward to its reset start position adjacent the upper portion of the tank 1 and below the strainer basket 7.

Various features and advantages of the invention are set forth in the following claims.

What is claimed is:

1. A percolating device comprising:
a tank operable to hold liquid and having a top portion, a side wall, and a bottom portion;
a strainer basket positioned inside and near the top portion of the tank and operable to contain coffee grounds;
a heating element operable to heat a liquid contained in the tank;
a tube operable to direct heated liquid from the heating element to the strainer basket such that the heated liquid enters the strainer basket; and
a partition sealably engaging the side wall of the tank, the partition operable to substantially separate liquid that has entered and fallen through the strainer basket from liquid that has not entered and fallen through the strainer basket.

2. The device of claim 1, wherein the partition includes a seal extending about an outer periphery of the partition for sealably engaging the side wall of the tank.

3. The device of claim 2, wherein the seal is annular in shape.

4. The device of claim 2, wherein the seal is a low durometer, high temperature resistant elastomer.

5. The device of claim 1, wherein the tube is centrally located within the tank, and wherein the partition includes a seal centrally located on the partition for sealably engaging the tube.

6. The device of claim 1, wherein the partition automatically moves from a position adjacent the top portion of the tank to a position adjacent the bottom portion of the tank as the amount of liquid that has fallen through the strainer basket increases and an amount of liquid below the partition decreases.

7. The device of claim 6, wherein the device further includes a switch adjacent the bottom portion of the tank, the switch being triggered by the partition as the partition moves to the position adjacent the bottom portion of the tank to change operation of the heating element.

8. The device of claim 6, further comprising a spigot coupled to the tank at an exit orifice to permit flow of liquid from the tank, the spigot allowing flow therefrom of liquid that has fallen through the strainer basket only after the partition has moved below the exit orifice to the position adjacent the bottom portion of the tank.

9. The device of claim 1, wherein the partition includes a thermally conductive material.

10. The device of claim 9, wherein the partition includes at least one of stainless steel and aluminum.

11. The device of claim 1, wherein the tank includes at least one window aperture that provides a visual indication of brewing progress by permitting viewing of the partition location within the tank, the liquid that has fallen through the strainer basket, and the liquid that has not yet fallen through the strainer basket.

12. The device of claim 1, wherein the partition includes means for releasing air from underneath the partition.

13. The device of claim 12, wherein the means for releasing air from underneath the partition includes an aperture in the partition through which air can pass.

14. The device of claim 13, wherein the partition includes a seal, and wherein the aperture is in the seal.

15. The device of claim 12, wherein the means for releasing air from underneath the partition includes a close slide fit engagement between the partition and the tube that does not result in a complete seal.

16. A method of brewing coffee using a percolating device having a tank with a top portion, a side wall, and a bottom portion, the method comprising:
providing heated water from the bottom portion of the tank through a tube to a strainer basket containing coffee grounds and that is positioned inside and adjacent the top portion of the tank;
passing the provided heated water through the strainer basket such that the heated water exits from the strainer basket as coffee and remains in the tank; and
substantially separating the coffee from the remainder of the water in the tank that has not been provided to and passed through the strainer basket.

17. The method of claim 16, wherein providing heated water from the bottom portion of the tank through a tube includes flowing the heated water through a tube that is centrally located within the tank.

18. The method of claim 17, wherein substantially separating the coffee from the remainder of the water in the tank includes positioning a partition adjacent the top portion of the tank and below the strainer basket, the partition including a seal at its center to sealably engage the tube.

19. The method of claim 16, wherein substantially separating the coffee from the remainder of the water in the tank includes positioning a partition adjacent the top portion of the tank and below the strainer basket, the partition including a seal around its periphery to sealably engage the side wall of the tank.

20. The method of claim 19, wherein substantially separating the coffee from the remainder of the water in the tank further includes allowing the partition to automatically move from the position adjacent the top portion of the tank and below the strainer basket, to a position adjacent the bottom portion of the tank, due to an increasing amount of coffee above the partition and a decreasing amount of water below the partition.

21. The method of claim 20, further comprising releasing air from underneath the partition at a high point of the partition.

22. A partition for use in a percolator device, the partition comprising:
a disk having an outer periphery and a central aperture; and
a seal coupled to the outer periphery and configured to sealably engage a side wall of a tank of the percolator device.

23. The partition of claim 22, wherein the disk is made of a thermally conductive material and the seal is made of a low durometer, high temperature resistant elastomer.

24. The partition of claim 22, further including a second seal coupled to the central aperture and configured to sealably engage a tube of the percolator device that passes through the central aperture.
